(19) United States
(12) Patent Application Publication
(10) Pub. No.: US 2023/0064702 A1
(43) Pub. Date: Mar. 2, 2023

(54) HIGH Tg ACRYLATE COPOLYMERS WITH NITROGEN-CONTAINING AROMATIC HETEROCYCLIC GROUP

(71) Applicant: TESA SE, Norderstedt (DE)

(72) Inventors: Christian SCHUH, Hamburg (DE); Helmut RITTER, Wuppertal (DE); Laura HARTMANN, Düsseldorf (DE); Moniralsadat TABATABAI, Düsseldorf (DE); Philipp REUTHER, Düsseldorf (DE)

(73) Assignee: TESA SE, Norderstedt (DE)

(21) Appl. No.: 17/797,155

(22) PCT Filed: Jan. 14, 2021
(86) PCT No.: PCT/EP2021/050695

§ 371 Date: Aug. 3, 2022

(30) Foreign Application Priority Data
Feb. 4, 2020 (DE) 10 2020 201 334.9

(51) Int. Cl. C08F 226/06; C08F 226/02; C08F 220/14; C08F 2/06; C08F 2/38; C09J 7/38

(52) U.S. Cl. CPC C08F 226/06; C08F 226/02; C08F 220/14; C08F 2/06; C08F 2/38; C09J 7/38; C08F 2800/10; C09J 2463/00; C09J 2301/302; C09J 2301/408; C09J 2301/414

(57) ABSTRACT

The invention relates to a process for the radical polymerization for preparing a copolymer, using specific monomers A, which have a glass transition temperature Tg of at least 0° and specific monomers B, which contain an aromatic heterocyclic group that contain at least one nitrogen atom in the ring. The invention also relates to copolymers that are obtained by the radical polymerization, to the use of same as accelerators in a curing reagent for adhesive compounds, and to adhesive strips containing same.

The invention relates to a process for the radical polymerization for preparing a copolymer with specific monomers A which have a Tg of at least 0° C. and specific monomers B which contain an aromatic heterocyclic group containing at least one nitrogen atom in the ring. The invention further relates to the copolymers which are obtained by the radical polymerization, to the use of these as accelerators in the curing reagent for adhesives, and to adhesive tapes which comprise them.

For reactive adhesive tapes, which can be produced both from solution and from the melt, there is a need for storable, temperature-resistant and/or solvent-resistant polymers as accelerators for the curing reaction. Many of the systems presently available commercially contain substituted imidazoles or urea derivatives.

For example the following accelerators are known in the prior art:

CN 106432584 A discloses acrylate copolymers with imidazole groups, which consist otherwise of low-Tg comonomers, such as HEA (−20° C.), EHA (−58° C.) and LA (−17° C.). The typical rubber-toughening materials to which that application relates are based on phase-separated low-Tg polymers which are able to intercept impacts on the hard epoxy network.

CN 104387525 A1 discloses terpolymers of three different monomers. The polymers contain monomers in fractions of more than 10 mol % which as their homopolymer have a Tg lower than 0° C. A further requirement of the process is the preparation first of an epoxy polymer, to which an imidazole derivative is bonded on in a second step.

US 2002098361 A1 describes copolymers composed of monomers of N-vinyl derivatives and acrylates. The homopolymers of the acrylates are in this case to have a Tg of less than 0° C. The publication does not disclose any copolymer in which a monomer having a Tg of at least 0° C. is used in at least 30 mol %. The resulting polymers of that publication are low Tg polymers, since the systems in question are pressure-sensitive adhesives.

U.S. Pat. No. 4,071,653 discloses acrylate copolymers which can consist of at least 50% of methyl methacrylate monomers and up to 10% of vinylpyrrolidone, amides, methylolamides, methylol ether amides. Monomers with aromatic heterocyclic nitrogen containing groups are not disclosed.

US 2011159195 A1 describes pressure-sensitive acrylate adhesives where the polymers are low Tg polymers. The illustrative polymers all have a 2-ethylhexyl acrylate of at least 70%, which as a homopolymer has a Tg of around −56° C.

US 2013/190468 A1 discloses low Tg polymers which contain between 30 and 70% of a low Tg monomer. There is no further disclosure of monomers with heteroaromatic groups which contain nitrogen.

A disadvantage which may be perceived is that the polymers stated above are not suitable as accelerators, which are exposed to high temperatures in the production process. Particularly when adhesive tapes are produced from the melt, the amount of energy introduced into the system is greater than for conventional reactive liquid adhesives. The majority of the accelerators presently known do not withstand an extrusion step at up to 100° C. which prevails in the case of production from the melt, or are not sufficiently active in their quality as accelerators in the final cure. The object of the present invention, accordingly, was to provide a stable accelerator, particularly at 100° C., which in spite of the high temperature stability exhibits a sufficient accelerating effect, especially on an epoxy-dicyanamide reaction.

The object has been achieved by means of the specific copolymers of the present invention and their preparation process.

The invention accordingly relates in a first aspect to a process for the radical polymerization for producing a copolymer, comprising or consisting of the step of:

polymerizing of

at least one monomer A which contains at least one unsaturated —C═C— double bond and has a T_{g≥}0° C., determined from the homopolymer of the monomer A by means of DSC measurement;

at least one monomer B which contains an aromatic heterocyclic group containing at least one nitrogen atom in the ring and which further contains at least one unsaturated —C═C— double bond;

and

optionally at least one monomer C which contains at least one unsaturated —C═C— double bond that is different from monomer A and B;

in the presence of at least one radical initiator and optionally of at least one chain transfer agent; where the at least one monomer A is contained in at least 30 mol % based on the total monomers of the copolymer.

In a second aspect the invention relates to a copolymer obtainable by the radical polymerization in accordance with the present invention.

In a third aspect the invention relates to an adhesive tape comprising at least one layer of a pressure-sensitive adhesive,

where the adhesive comprises a polymeric film-forming matrix and also a curable composition,

where the curable composition comprises one or more epoxy resins and also at least one curing reagent for epoxy resins,

characterized in that

the curing reagent comprises at least one copolymer of the present invention and at least one hardener.

Lastly the present invention in a fourth aspect relates to the use of the copolymer of the present invention as an accelerator in the curing reagent for adhesives.

“At least one”, as used herein refers to 1 or more, as for example 2, 3, 4, 5, 6, 7, 8, 9 or more. In connection with constituents of the compounds described herein, this indication refers not to the absolute amount of molecules, but rather to the nature of the constituent. “At least one monomer A” therefore means, for example, that there may be only one kind of monomer A or two or more different kinds of monomers A present, without indications as to the amount of the individual compounds.

All quantity figures reported in connection with the compositions described herein refer, unless otherwise indicated, to wt % based in each case on the total weight of the composition. Quantity figures of this kind which refer to at least one constituent refer, furthermore, always to the total amount of this type of constituent which is contained in the composition, unless something different is explicitly indicated. This means that quantity figures of this kind, in connection for example with “at least one monomer A”, refer to the total amount of monomers A which are contained in the reaction or in the polymer, unless something different is explicitly indicated.

Numerical values which are given herein without decimal places refer in each case to the full specified value with one decimal place. For example, “99%” stands for “99.0%”.

The expressions “approximate”, “around” or “about”, in connection with a numerical value, refer to a variance of ±10% based on the specified numerical value, preferably ±5%, more preferably ±1%, more preferably still below ±0.1%.

Numerical ranges which are reported in the format “in/from/of x to y” include the stated values. Where two or more preferred numerical ranges are given in this format, it is self-evident that all of the ranges formed by combining the different end points are likewise included.

Figures relating to the molecular weight refer to the weight-average molecular weight in g/mol, unless the number-average molecular weight is explicitly stated. Molecular weights are ascertained preferably by means of GPC using polystyrene standards.

These and further aspects, features, and advantages of the invention become apparent for the skilled person from a study of the following detailed description and claims. In this context, any feature or any embodiment from one aspect of the invention may be used in any other aspect of the invention. For example, features or embodiments of the process that are described may also be applied to the copolymer claimed, and vice versa. It is self-evident, furthermore, that the examples contained herein are intended to describe and illustrate the invention, but not to limit it, and the invention in particular is not restricted to these examples.

The present invention relates more particularly to a process for the radical polymerization for preparing a copolymer, comprising or consisting of the step of:

polymerizing of

at least one monomer A which contains at least one unsaturated —C═C— double bond and has a T_{g≥}0° C., preferably ≥40° C., more preferably ≥70° C., most preferably ≥90° C., determined from the homopolymer of the monomer A by means of DSC measurement;

at least one monomer B which contains an aromatic heterocyclic group containing at least one nitrogen atom in the ring and which further contains at least one unsaturated —C═C— double bond;

and

optionally at least one monomer C which contains at least one unsaturated —C═C— double bond that is different from monomer A and B, and is preferably contained in less than 10 mol %, more preferably less than 5 mol %, most preferably 0 mol %, based on the total monomers of the copolymer;

in the presence of at least one radical initiator and optionally of at least one chain transfer agent; where the at least one monomer A is contained in at least 30 mol % based on the total monomers of the copolymer.

The at least one monomer A may preferably have a molecular weight of less than 1000 g/mol, more preferably less than 750 g/mol, most preferably less than 500 g/mol.

The at least one monomer A is different from the at least one monomer B and, if present, from the at least one monomer C. In one preferred embodiment the at least one monomer A comprises no nitrogen containing aromatic heterocyclic group.

The at least one monomer A is preferably selected from acenaphthylene, maleic anhydride, N-phenylmaleimide, N-vinylpyrrolidone, 2-vinylnaphthalene acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxystyrene, alpha-methylstyrene, 3-methylstyrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, stearyl acrylate, vinyl acetate, n-butyl methacrylate, methyl acrylate, 2-phenoxyethyl acrylate, 2-(3-toloidylureido)ethyl methacrylate or mixtures thereof.

In an alternative preferred embodiment the at least one monomer A is selected from acenaphthylene, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxystyrene, 3-methylstyrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, 2-(3-toloidylureido)ethyl methacrylate or mixtures thereof.

In an alternative preferred embodiment the at least one monomer A is selected from acenaphthylene, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxystyrene, 3-methylstyrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, phenyl methacrylate, 3,4-epoxycyclohexylmethyl methacrylate, glycidyl methacrylate, 2-(3-toloidylureido)ethyl methacrylate or mixtures thereof.

In an alternative preferred embodiment the at least one monomer A is selected from acenaphthylenes, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxystyrene, 3-methylstyrene, 4-methylstyrene, N,N-dimethylacrylamide, N-tert-butylacrylamide, N-isopropylacrylamide, isobornyl acrylate, acrylonitrile, methacrylonitrile, phenyl methacrylate, 2-(3-toloidylureido)ethyl methacrylate or mixtures thereof.

In a further alternative preferred embodiment there are at least two different kinds of monomer A present. In a more strongly preferred embodiment one monomer A is N-phenylmaleimide and the other monomer A is selected from acenaphthylenes, maleic anhydride, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxystyrene, alpha-methylstyrene, 3-methylstyrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, stearyl acrylate, vinyl acetate, n-butyl methacrylate, methyl acrylate and 2-phenoxyethyl acrylate, 2-(3-toloidylureido)ethylmethacrylat.

The at least one monomer A is contained preferably in 30 to 70 mol %, more preferably 35 to 60 mol %, more particularly 35% to 60 mol %, based on the total monomers of the copolymer.

The at least one monomer B, contains an aromatic heterocyclic group containing at least one nitrogen atom in the ring, and further contains at least one unsaturated —C═C— double bond. For the purposes of the present invention the unsaturated —C═C— bond is not part of the ring of the aromatic heterocyclic group. In one preferred embodiment it is a terminal —C═CH₂ or —CCH₃═CH₂ group. These radicals may directly replace a hydrogen atom on the aromatic heterocyclic group or may be bonded to the aromatic heterocyclic group via a spacer group.

The at least one monomer B preferably has a molecular weight of less than 2000 g/mol, preferably less than 1500 g/mol, more preferably less than 1000 g/mol.

In one preferred embodiment the at least one monomer B contains imidazole, pyridine or derivatives thereof as aromatic heterocyclic group containing at least one nitrogen atom in the ring, more preferably imidazole or derivatives thereof. For the purposes of the present invention the respective derivatives derived from pyridine and imidazole, where one or more hydrogen atoms may have been replaced by alkyl radicals or other organic groups, such as ketone radicals and aldehyde radicals, for example, more particularly by methyl, ethyl, propyl, butyl, pentyl, and hexyl.

In a further preferred embodiment the aromatic heterocyclic group of the monomer B that contains at least one nitrogen atom in the ring is bonded to the polymer backbone of the resultant copolymer by a spacer group, more particularly by a substituted or unsubstituted alkyl group, a substituted or unsubstituted —C(═O)— alkyl group, a substituted or unsubstituted —C(═O)-alkyl-NH—C(═O)—NH—group, having 2 to 20, preferably 2 to 6, more preferably 2 to 4 atoms. If present, the spacer group bonds to the polymer backbone via the carbon atom of the —C(═O)— unit of the respective group. “Substituted” here means that one or more hydrogen atoms of the respective alkyl unit may have been replaced by —F, —CI, —Br, —CH₃, —CH₂CH₃, —OH or —CF₃. Preferably there is in each case one unsubstituted alkyl unit present.

In one preferred embodiment the terminal —CH═CH₂ or —CCH₃═CH₂ group in the monomer B is bonded to the aromatic heterocyclic group by a spacer group, more particularly by a substituted or unsubstituted alkyl group, a substituted or unsubstituted —C(═O)— alkyl group, a substituted or unsubstituted —C(═O)-alkyl-NH—C(═O)—NH—group, having 2 to 20 or 2 to 10, preferably 2 to 6, more preferably 2 to 4 atoms, where the spacer group here replaces a hydrogen atom of the aromatic heterocyclic group. If present, the spacer group bonds to the —CH═CH₂ or —CCH₃═CH₂ group via the carbon atom of the —C(═O)— unit of the respective group, meaning that (meth)acrylate monomers are present. “Substituted” here means that one or more hydrogen atoms of the respective alkyl unit may have been replaced by —F, —CI, —Br, —CH₃, —CH₂CH₃, —OH or —CF₃. Preferably there is in each case one unsubstituted alkyl unit present.

The backbone is understood in the sense of the invention to be the longest chain of the polymer resulting from the polymerization of the unsaturated double bonds of the monomers A and B and optionally C.

Shown below is a nonlimiting example of the backbone and a spacer group having four atoms:

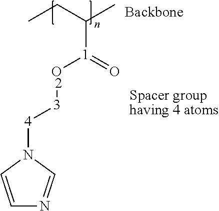

In one preferred embodiment the monomer B contains no —OH radical.

In one preferred embodiment the at least one monomer B is selected from imidazoleethyl methacrylate, imidazoleethyl acrylate, 2-methylimidazolethyl methacrylate, 2-methylimidazolethyl acrylate, methylaminopyridineethyl methacrylate, methylaminopyridineethyl acrylate, vinylimidazole, imidazoleethylurethane methacrylate, N-methyl-N-(4-pyridyl)amino)ethyl methacrylate or mixtures thereof, more particularly imidazoleethyl methacrylate, imidazoleethyl acrylate, 2-methylimidazolethyl methacrylate, 2-methylimidazolethyl acrylate, methylaminopyridineethyl methacrylate, methylaminopyridineethyl acrylate or mixtures thereof.

The at least one monomer B is contained preferably in 20 to 70 mol %, more preferably 25 to 60 mol %, more particularly 35 to 60 mol %, based on the total monomers of the copolymer.

In one preferred embodiment the monomers A are present relative to the monomers B in a molar ratio of 30 to 60:40 to 70, preferably 40 to 60:40 to 60.

The monomers C are preferably monomers having a Tg of less than 0° C. They likewise contain an unsaturated —C═C— group, preferably a terminal —CH═CH₂ or —CCH₃═CH₂ group. In one preferred embodiment there are substantially no monomers C present, and more particularly no monomers C are present.

The reaction takes place in the presence of at least one radical initiator. Suitability here is possessed by all of the radical initiators known to the skilled person in the field of radical polymerization. These include UV radical initiators, which are activated by UV irradiation, and thermal radical initiators, which are activated thermally. Especially suitable are radical initiators which are used for the polymerization of (meth)acrylates. In one preferred embodiment the at least one radical initiator is azobisisobutyronitrile.

In one preferred embodiment the at least one radical initiator is contained in less than 10 mol %, preferably in at most 5 mol %, based on the sum of the monomers A to C, which is 100 mol %.

The reaction is preferably carried out in at least one organic solvent, preferably selected from toluene, acetone, butanone, ethyl acetate, 2-propanol, dimethylformamide, and mixtures thereof.

The reaction is also preferably carried out under protective gas atmosphere, more particularly under a nitrogen or argon atmosphere.

In the reaction it is also possible to use at least one chain transfer agent, which is preferably mercaptoethanol. In one preferred embodiment the at least one chain transfer agent is contained preferably in less than 10 mol %, preferably in at most 5 mol %, based on the sum of the monomers A to C, which are 100 mol %.

The polymerization is preferably carried out with heating, more preferably at a temperature of at least 35° C., more preferably still at least 50° C., most preferably at least 65° C., the temperature preferably being not higher than 120° C. In one preferred embodiment the reaction time is at least 1 h, preferably at least 6 h, more preferably at least 22 h.

The radical polymerization of the present invention affords a copolymer which is likewise a subject of the invention.

The copolymer obtained preferably has a Tg of 40 to 200° C., measured by DSC. Particularly for the shelf life a Tg is preferred which is at least 20° C. above the processing temperature. Where the reactive adhesive is processed at 80° C., the Tg of the copolymer, accordingly, is preferably greater than 100° C., although in order to maximize reactivity, the Tg of the copolymer is ideally lower than the curing temperature. In other words, in the case of a curing temperature of 160° C., 140° C. or 130° C., for example, the Tg accordingly is less than 160° C., less than 140° C. or less than 130° C., respectively.

The Tg is preferably also at least 20° C. higher than the storage temperature—in other words, in the case of room temperature storage (20° C.), the Tg is at least 40° C. If higher temperatures are attained during transportation, the Tg accordingly is preferably 60° C., more particularly 80° C. The copolymer also preferably has a weight-average molecular weight Mw of at least 1000 g/mol, more preferably 2000 g/mol. A particularly effective trade-off between long shelf life and reactivity is achieved if the molecular weight is not greater than 500000 g/mol, more particularly 200000 g/mol, and is preferably between 2000 and 100000 g/mol.

The copolymer of the invention that is obtained is used as an accelerator in the curing reagent for adhesives, more particularly epoxy-based adhesives.

The invention further relates to an adhesive tape comprising at least one layer of a pressure-sensitive adhesive,

where the adhesive comprises a polymeric film-forming matrix and also a curable composition,

where the curable composition comprises one or more epoxy resins and also at least one curing reagent for epoxy resins,

characterized in that

the curing reagent comprises at least one copolymer of the present invention and at least one hardener.

In one preferred embodiment at least one of the epoxy resins of the curable composition is an elastomer-modified, more particularly nitrile rubber-modified, epoxy resin, and/or a fatty acid-modified epoxy resin.

In another preferred embodiment the polymeric film-forming matrix used comprises wholly or partly one or more thermoplastic polyurethanes or one or more non-thermoplastic elastomers.

In the subsequent section, which relates to the adhesives, the copolymers of the present invention are also referred to as accelerators.

It is possible advantageously to use, for example, 5 to 80 parts by weight at least of the polymeric film-forming matrix (M) and 20 to 95 parts by weight of the one epoxy resin or of the sum of epoxy resins, when the parts by weight of the film-forming matrix and of the epoxy resins add up to 100. The amount of curing reagent to be used with preference may vary according to the copolymer and any hardeners used—on this point, see later on below. For the purposes of the present invention, a curing reagent comprises at least one copolymer, i.e., accelerator, of the present invention and at least one hardener.

The curing of the adhesive, here also referred to as curable composition, is accomplished in particular by the reaction of one or more reactive resins with one or more polymers of the invention and hardeners. The curable composition comprises as reactive resin at least one epoxy resin, but may also comprise two or more epoxy resins. The one epoxy resin or the two or more epoxy resins may be the only reactive resins in the curable composition, more particularly, therefore, the only components of the curable composition which can lead with the curing reagent—after corresponding activation where appropriate—to curing of the composition. In principle, however, it is also possible for resins present to comprise not only the epoxy resin or epoxy resins but also further reactive resins which are not epoxy resins.

The one or more epoxy resins used are, for example and advantageously, one or more elastomer-modified, more particularly nitrile rubber-modified, epoxy resins and/or one or more silane-modified epoxy resins and/or one or more fatty acid-modified epoxy resins.

Reactive resins are crosslinkable resins, these being oligomeric or short-chain polymeric compounds, more particularly those having a number-average molar mass Mₙ of not more than 10 000 g/mol, which comprise functional groups; more particularly, those having multiple functional groups in the macromolecule. Since the resins comprise a distribution of macromolecules having different individual masses, the reactive resins may contain fractions whose number-average molar mass is significantly higher, as for example up to about 100 000 g/mol; this is true especially of polymer-modified reactive resins, such as elastomer-modified resins, for example.

Reactive resins differ from tackifier resins which are frequently used for adhesives, particularly for pressure-sensitive adhesives. In accordance with the general understanding of the skilled person, a “tackifier resin” is an oligomeric or polymeric resin which raises only the adhesion (the tack, the intrinsic stickiness) of the pressure-sensitive adhesive by comparison with the tackifier resin-free but otherwise identical pressure-sensitive adhesive. Apart from double bonds (in the case of the unsaturated resins), tackifier resins typically contain no reactive groups, as the intention is that their properties should not change over the lifetime of the pressure-sensitive adhesive.

The functional groups of the reactive resins are such that under suitable conditions—more particularly after activation by, for example, increased temperature (thermal energy) and/or actinic radiation (such as light, UV radiation, electron beams, etc.) and/or by initiation and/or catalysis by further chemical compounds, such as, for instance, water (moisture-curing systems)—they lead, with a curing reagent, to curing of the composition comprising the reactive resins and the curing reagent, more particularly in the sense of a crosslinking reaction.

Epoxy resins in the context of this specification are reactive resins comprising epoxy groups, more particularly those resins having more than one epoxy group per molecule, in other words reactive resins wherein the functional groups or at least some of the functional groups are epoxy groups. During the curing reaction of the curable composition, the epoxy resins are transformed in particular via polyaddition reactions with suitable epoxy hardeners and/or by polymerization via the epoxy groups. Depending on the epoxy hardener selected, it is also possible for both reaction mechanisms to run in parallel.

Hardeners in the context of this specification and in accordance with DIN 55945: 1999-07 refer to the one or more chemical compounds—acting as binder(s)—which are added to the crosslinkable resins in order to bring about the curing (crosslinking) of the curable composition, more particularly in the form of an applied film. Within the curable compositions, correspondingly, hardener is the term for the component which brings about the chemical crosslinking after the mixing with the reactive resins and corresponding activation.

Accelerators in the context of this specification are those chemical compounds which, in the presence of a different hardener, increase the reaction rate of the curing reaction and/or the rate of activation of the curing of the epoxy resins, particularly in a synergistic way. The hardener system of the present invention comprises as accelerator at least one copolymer of the present invention.

Adhesive Tape

The curable composition of the adhesive tape of the invention is preferably an adhesive, more particularly a reactive adhesive, very preferably a reactive adhesive or adhesive which is pressure-sensitively adhesive at room temperature (23° C.).

Adhesives (according to DIN EN 923: 2008-06) are nonmetallic substances that join adherends via surface adhesion and internal strength (cohesion). Adhesives may be self-adhesive and/or develop their ultimate bonding force only through particular activation, as for instance through thermal energy and/or actinic radiation. Reactive adhesives (which may be self-adhesive or nonadhesive prior to activation) comprise chemically reactive systems which are able to lead to a curing reaction through activation and are able to develop particularly high bonding forces (more particularly greater than 1 MPa) to the substrates on which they are bonded.

The curing or consolidation is achieved through chemical reaction of the reactants with one another. In contrast to pressure-sensitive adhesives that are regularly also crosslinked to increase cohesion but still have viscoelastic properties even after crosslinking, and more particularly do not undergo any further consolidation after bonding, it is generally only the curing, in the case of reactive adhesives, that leads to the actual bonding with the desired bonding forces; the adhesive itself after curing is frequently thermoset or largely thermoset (“paintlike”).

The attribute “pressure-sensitively adhesive”—and as a constituent of nouns, such as, for instance, in pressure-sensitive adhesive—or synonymously with the attribute “self-adhesive”—likewise also as a constituent of nouns—is understood in the context of this specification to refer to those compositions which even under relatively gentle applied pressure—unless otherwise indicated, at room temperature, i.e., 23° C.— permit a lasting bond to the substrate and, after use, can be detached from the substrate again substantially without residue. Pressure-sensitive adhesives (PSAs) are used preferably in the form of adhesive tapes. For the purposes of the present invention, a pressure-sensitive adhesive tape possesses a peel adhesion in the uncured state of at least 1 N/cm. The peel adhesion here is determined as the bonding force to steel in analogy to ISO 29862:2007 (Method 3) at 23° C. and 50% relative humidity with a peel velocity of 300 mm/min and a peel angle of 180°. The reinforcing film used is an etched PET film having a thickness of 36 μm, as available from Coveme (Italy). The bonding of a 2 cm-wide test strip is undertaken here by means of a roll applicator at 4 kg and a temperature of 23° C. The adhesive tape is peeled off immediately after application. The measured value (in N/cm) was obtained as the average value from three individual measurements.

PSAs are permanently pressure-sensitively adhesive at room temperature, therefore, and thus have sufficiently low viscosity and high tack so that they wet the surface of the respective substrate even at low applied pressure. The bondability of the PSAs is based on their adhesive properties, and the redetachability on the cohesive properties.

Pressure-sensitive reactive adhesives have pressure-sensitive properties at room temperature (and in this state in particular are viscoelastic), but during and after curing they have the characteristics of reactive adhesives.

In accordance with the invention the curable composition, more particularly the PSA, is used in the form of a film or, preferably, layer, as a constituent of an adhesive tape.

For this purpose the curable composition, more particularly the PSA, is applied preferably as a layer to a permanent or temporary carrier, more particularly by the coating methods known to the skilled person. The material in sheet form is coated preferably without solvent, as for example by means of nozzle coating or using a multiroll applicator unit. This can be accomplished particularly effectively and advantageously with a 2- to 5-roll applicator unit, such as with a 4-roll applicator unit, for example, so that the self-adhesive composition is shaped to the desired thickness as it passes through one or more roll nips before being transferred onto the sheet material. The rolls of the applicator unit here may be adjusted individually to particular temperatures, such as to temperatures at 20° C. to 150° C., for example.

Permanent carriers are in particular a lasting constituent of single-sided or double-sided adhesive tapes, in which one or both, respectively, of the external faces of the adhesive tape is or are formed by a layer of (pressure-sensitive) adhesive. For improved handling, the layers of adhesive may be lined with antiadhesive release layers, such as siliconized papers, for instance, which are removed in each case for bonding.

The general expression “adhesive tape” accordingly embraces on the one hand a carrier material which is provided on one or both sides with a (pressure-sensitive) adhesive and which may optionally have further layers in between.

More particularly the expression “adhesive tape” in the sense of the present invention embraces what are called “adhesive transfer tapes”, these being adhesive tapes without permanent carriers, more particularly single-layer adhesive tapes without permanent carriers.

Adhesive transfer tapes of the invention of this kind are applied to a temporary carrier prior to application. Serving as temporary carriers in this case, in particular, are flexible filmlike materials (polymeric films, papers or the like) which carry a release layer (having been siliconized, for example) and/or which have antiadhesive properties (being referred to as release materials, liners or release liners).

Temporary carriers serve in particular to provide single-layer or otherwise non-self-supporting adhesive tapes—which therefore consist in particular only of the layer of (pressure-sensitive) adhesive—with handling qualities and protection.

The temporary carrier is usually removable and is removed on application (generally after the application of the free surface of the adhesive tape to the first substrate and before the bonding of the other, initially lined adhesive tape surface to the second substrate), allowing the layer of adhesive to be utilized as a double-sided adhesive tape.

Prior to application, adhesive transfer tapes of the invention may also have two temporary carriers, with the adhesive present in the form of a layer between them. In that case, for application, first one liner is generally removed, the adhesive is applied, and then the second liner is removed. The adhesive tape can be used accordingly for the joining of two surfaces directly. Carrier-free adhesive transfer tapes of this kind are particularly preferred in the invention. A pressure-sensitively adhesive, carrier-free adhesive transfer tape of the invention of this kind enables very precise bonding in terms of positioning and dosing.

Also possible are adhesive tapes which operate not with two liners but instead with a single liner furnished for double-sided release. The sheet of adhesive tape is in that case lined on its top side with the one side of a liner furnished for double-sided release, while its bottom side is lined with the rear side of the liner furnished for double-sided release, more particularly with an adjacent turn on a bale or a roll.

Adhesive tapes, irrespective of whether they have a carrier or are carrier-free, i.e., adhesive transfer tapes, adhesive tapes differ from layers of adhesive present for instance in the form of liquid adhesive on a substrate, in that the adhesive tapes are self-supporting, and can accordingly be employed as an independent product. For this purpose the layer of adhesive has sufficient cohesion and/or the entirety of the layers forming the adhesive tape have in particular a sufficient stability.

Adhesive tapes coated on one or both sides with adhesives usually end their production process by being wound up into a roll in the form of an Archimedean spiral or in cross-wound form. To prevent the adhesives making contact with one another in the case of double-sided adhesive tapes, or to prevent the adhesive sticking to the carrier in the case of single-sided adhesive tapes, the adhesive tapes prior to winding, if not already present on a liner, may be covered advantageously on one or both sides with a liner, which is wound up together with the adhesive tape. As well as for the lining of single-sided or double-sided adhesive tapes, liners are also used for the covering of pure adhesives (adhesive transfer tape) and adhesive-tape sections (e.g., labels). These liners additionally ensure that the adhesive is not soiled prior to the application.

Film Former Matrix

The adhesive tape of the invention comprises a polymeric film former matrix which contains the curable composition comprising at least one epoxy resin and at least one curing reagent for the epoxy resin. Adhesive tapes of these kinds thus comprise an adhesive film, which is formed fundamentally of a polymeric film-forming matrix (referred to as “film former matrix” for short in the context of this specification) with the curable composition embedded therein, said composition serving more particularly as a reactive adhesive. The film former matrix here forms a self-supporting three-dimensional film (with the spatial extent in the thickness direction of the film generally being very much smaller than the spatial extents in longitudinal and transverse directions, in other words than in the two spatial directions of the two-dimensional extent of the film; with regard to the meaning of the term “film”, see also later on below). The curable composition, more particularly the reactive adhesive, preferably has a substantially spatially equal distribution (homogeneous) in this film former matrix, especially such that the reactive adhesive—which without the matrix might not be self-supporting—assumes substantially the same (macroscopic) spatial distribution in the adhesive film of the invention as does the film former matrix.

The function of this matrix is to form an inert skeleton for the reactive monomers and/or reactive resins, so that they are incorporated in a film or a foil. Hence it is also possible for otherwise liquid systems to be supplied in film form. In this way, easier handling is ensured. The parent polymers of the film former matrix are capable, as a result of sufficient interactions of the macromolecules with one another, of being able to form a self-supporting film, for example—without wishing hereby to restrict the concept of the invention unnecessarily—by formation of a network on the basis of physical and/or chemical crosslinking.

“Inert” in this context means that the reactive monomers and/or reactive resins, under suitably selected conditions (e.g., and sufficiently low temperatures), undergo substantially no reaction with the polymeric film former matrix.

Suitable film former matrices for use in the present invention are preferably a thermoplastic homopolymer or a thermoplastic copolymer (referred to collectively in the context of this specification as “polymers”), or a blend of thermoplastic homopolymers or of thermoplastic copolymers, or of one or more thermoplastic homopolymers with one or more thermoplastic copolymers. In one preferred procedure, use is made in whole or in part of semicrystalline thermoplastic polymers.

Thermoplastic polymers selected may in principle be, for example, polyesters, copolyesters, polyamides, copolyamides, polyacrylic esters, acrylic ester copolymers, polymethacrylic esters, methacrylic ester copolymers, thermoplastic polyurethanes, and chemically or physically crosslinked substances of the aforementioned compounds. The stated polymers may each be used as a polymer on its own or as a component of a blend.

In addition, elastomers and—as representatives of the aforementioned thermoplastic polymers—thermoplastic elastomers are also conceivable, alone or in a mixture, as polymeric film former matrix. Preference is given to thermoplastic elastomers, more particularly semicrystalline representatives. The stated—especially thermoplastic—elastomers may each be used as a polymer on its own or as a component of a blend, for example with further elastomers and/or thermoplastic elastomers and/or other thermoplastic polymers, such as those representatives identified in the preceding paragraph, for example.

Particularly preferred thermoplastic polymers are those having softening temperatures of less than 100° C. In this context the term “softening temperature” stands for the temperature at which the thermoplastic pellets start to stick to one another. If the constituent of the polymeric film former matrix is a semicrystalline thermoplastic polymer, it preferably has, as well as its softening temperature (which is connected to the melting of the crystallites), a glass transition temperature of at most 25° C., preferably at most 0° C.

One preferred embodiment in the invention uses a thermoplastic polyurethane. The thermoplastic polyurethane preferably possesses a softening temperature of less than 100° C., more particularly less than 80° C.

In one particularly preferred embodiment in the invention, Desmomelt 530® is used as polymeric film former matrix, being available commercially from Bayer Material Science AG, 51358 Leverkusen, Germany. Desmomelt 530® is a hydroxyl-terminated, largely linear, thermoplastic, highly crystalline polyurethane elastomer.

It is possible advantageously for 5 to 80 parts by weight, for example, at least of the polymeric film former matrix to be used within a reactive film of adhesive. The amount of the polymeric film former matrix within a reactive film of adhesive is preferably, in the invention, in the range from about 15 to 60 wt %, preferably about 30 to 50 wt %, based on the total amount of polymers of the polymeric film former matrix and reactive resins of the curable composition. Adhesives having particularly high bond strengths after curing are obtained if the fraction of the film former matrix is in the range from 15 to 25 wt %. Adhesives of this kind, especially with less than 20% film former matrix, are very soft in the uncured state, lacking dimensional stability. The dimensional stability is improved when more than 20 wt %, more particularly more than 30% is used. Between 40 and 50 wt %, PSAs are obtained which in terms of dimensional stability exhibit the best properties, although there is a fall in the maximum attainable bond strength. Very well-balanced adhesives in terms of dimensional stability and bond strength are obtained in the range from 30 to 40 wt % of film former matrix. The wt % figures above are based here in each case on the sum of the epoxy resins and polymers forming the film former matrix.

In a further very preferred procedure, nonthermoplastic elastomers are used as matrix polymers. The nonthermoplastic elastomers may more particularly be a nitrile rubber or a mixture of two or more nitrile rubbers, or a mixture of one or more other nonthermoplastic elastomers with one or more nitrile rubbers.

Substances and/or compositions referred to as “nonthermoplastic” in the sense of the present specification are those which on heating to a temperature of 150° C., preferably on heating to a temperature of 200° C., very preferably on heating to a temperature of 250° C. display no thermoplastic behavior, more particularly such that they are rated as not thermoplastic in the thermoplasticity test (see Experimental section).

The term “nitrile rubber” stands as usual for “acrylonitrile-butadiene rubber”, abbreviation NBR, derived from nitrile butadiene rubber, and refers to synthetic rubbers which are obtained by copolymerization of acrylonitrile and butadiene in proportions by mass of approximately 10:90 to 52:48 (acrylonitrile: butadiene).

Nitrile rubbers are produced virtually exclusively in aqueous emulsion. In the prior art, the resulting emulsions are either used as such (NBR latex) or else worked up to give a solid rubber.

The properties of the nitrile rubber depend on the ratio of the starting monomers and on the molar mass thereof. Vulcanizates obtainable from nitrile rubber have high resistance to fuels, oils, fats and hydrocarbons, and, compared to those made from natural rubber, feature more favorable aging characteristics, lower abrasion and reduced gas permeability.

Nitrile rubbers are available in a wide variety. The various types are distinguished not only by the acrylonitrile content but especially by the viscosity of the rubber. This is typically reported by the Mooney viscosity. This in turn is determined firstly by the number of chain branches in the polymer and secondly by the molar mass. A basic distinction is made in the polymerization between what is called cold polymerization and hot polymerization. Cold polymerization is typically effected at temperatures of 5 to 15° C. and, by contrast with hot polymerization, which is typically conducted at 30 to 40° C., leads to a smaller number of chain branches.

Nitrile rubbers suitable in accordance with the invention are available from a multitude of manufacturers, for example Nitriflex, Zeon, LG Chemicals and Lanxess.

Carboxylated nitrile rubber types form through terpolymerization of acrylonitrile and butadiene with small proportions of acrylic acid and/or methacrylic acid in emulsion. They are notable for high strength. The selective hydrogenation of the C═C double bond of nitrile rubber leads to hydrogenated nitrile rubbers (H—NBR) with increased stability to increasing temperature (up to 150° C. in hot air or ozone) or resistance to swelling agents (for example sulfur-containing crude oils, brake fluids or hydraulic fluids). Vulcanization is effected with customary sulfur crosslinkers or peroxides or by means of high-energy radiation.

As well as carboxylated or hydrogenated nitrile rubbers, there are also liquid nitrile rubbers. The molar mass of these is limited during the polymerization by the addition of polymerization regulators, and they are therefore referred to as liquid rubbers.

For the purpose of improved processability of rubbers, for example the pelletizing of pellets from large rubber bales prior to further processing in mixers, inert separating aids such as talc, silicates (talc, clay, mica), zinc stearate and PVC powders are frequently added to the rubbers.

In one execution variant of the invention, non-thermoplastic elastomers used are partly or exclusively those nitrile rubbers having an acrylonitrile content of at least 25%, preferably of at least 30%, very preferably of at least 35%.

Hot-polymerized nitrile rubbers have excellent usability as matrix polymers. Such nitrile rubbers are highly branched, and therefore have a particularly high tendency to incipient physical crosslinking, and hence show particularly good shear strengths even in the uncured state.

Curing Reagent

As already set out above, the curing reagent comprises the entirety of the accelerators present and at least one hardener, where at least one copolymer of the invention is present as accelerator.

Copolymers of the invention typically do not have to be used in stoichiometric amounts, based on the functionality of the epoxy resin to be cured, in order to display good action.

Typical amounts used are 15 to 35 parts by weight per 100 parts by weight of the epoxy resin(s) to be cured. If multiple copolymers of the invention are used, the sum total of the amounts used is advantageously within the aforementioned range.

In alternative embodiments, the amount of the copolymers of the invention used is preferably in the range from 0.1 to 10 parts by weight, especially from 0.5 to 5 parts by weight, more preferably from 1 to 3 parts by weight, based in each case on 100 parts by weight of the epoxy resin(s) to be cured—especially when the copolymer is used-for example in combination with dicyandiamide. In certain cases it is advantageous to use amounts in the range of 4-8 parts by weight.

The compositions may further contain curing reagent at least one further accelerator different from the copolymers of the present invention. They are known to the skilled person in the field of curable adhesives.

The curing reagent—in addition to the copolymer(s) of the invention—comprises one or more hardeners for the epoxy resins and optionally one or more further accelerators for the curing reaction of the epoxy resins, where these hardeners or accelerators are not copolymers of the invention.

Such additional hardeners or accelerators selected may especially advantageously be compounds from the following list: dicyandiamide, anhydrides, epoxy-amine adducts, hydrazides and reaction products of diacids and polyfunctional amines. Examples of useful reaction products of diacids and polyfunctional amines include reaction products of phthalic acid and diethylenetriamine.

In a very preferred execution of the invention, the curing reagent comprises dicyandiamide and one or more copolymers of the invention. Even further preferably, the curing reagent consists exclusively of dicyandiamide and one or more copolymers of the invention. In combination with dicyandiamide, the at least one copolymer of the invention acts as an accelerator, and thus increases the reaction rate of the curing reaction of the epoxy resin compared to the situation in which dicyandiamide is present as the sole component of the curing reagent.

The invention thus further provides an adhesive tape comprising at least one layer of a pressure-sensitive adhesive, where the adhesive comprises a polymeric film former matrix and a curable composition, where the curable composition comprises at least one epoxy resin and at least one curing reagent for the epoxy resin, and where the curing reagent comprises i) at least one copolymer of the invention and ii) dicyandiamide, or consists of these components.

Stoichiometric hardeners, for example dicyandiamide, are preferably used on the basis of the amount of epoxide in the adhesive. For this purpose, first of all, the EEW of the epoxy mixture is calculated by the following formula:

$${EEW}_{tot} = {m}_{tot} / \sum \frac{{m}_{i}}{{EEW}_{i}}$$

$$where$$

$${m}_{tot} = total {m}_{i}$$

$${m}_{i} = masses of the individual components i of the mixture$$

$${EEW}_{i} = epoxy equivalents of components i$$

The amount of hardener m_{H} is then found from the amine equivalent of the hardener (AEW) and the EEWₜₒₜ of the epoxy mixture as follows:

m_{H}=AEW*(mᵢ/EEWₜₒₜ)

The copolymers of the invention that act as accelerator are then advantageously used at 0.1 to 10 parts by weight, especially at 0.5 to 5 parts by weight, preferably at 1 to 3 parts by weight, based in each case on 100 parts by weight of the epoxy resin to be cured. In certain cases—in particular when the copolymers of the invention are a relatively weak accelerator—amounts in the range of 4-8 parts by weight are used.

If, in addition to the epoxy resins, other reactive resins are present in the curable composition, it is additionally also possible to add specific further hardeners and/or accelerators for reaction with these components.

Epoxy Resins

Epoxy resin(s) used in the curable composition may be a single epoxy resin or a mixture of epoxy resins. In principle, it is possible to use epoxy resins that are liquid at room temperature or epoxy resins that are solid at room temperature or mixtures thereof.

The one epoxy resin or at least one of the epoxy resins is preferably a solid; especially one having a softening temperature of at least 45° C. or one having a viscosity at 25° C. of at least 20 Pa s, preferably 50 Pa s, especially at least 150 Pa s (measured to DIN 53019-1; 25° C., shear rate 1×s⁻¹).

In a favorable execution of the adhesive tape of the invention, the epoxy resins comprise a mixture of epoxy resins that are liquid at 25° C. and solid at 25° C. The proportion of liquid epoxy resins in the epoxy resins (E) is especially 10% to 90% by weight, further preferably 20% to 75% by weight. The respective difference from 100% by weight of the epoxy resins is then made up by solid epoxy resins. Adhesive tapes with such ratios of liquid and solid epoxy components show particularly balanced adhesive properties in the uncured state. If an adhesive tape having particularly good adaptation properties is desired, the proportion of liquid epoxy components is preferably 50% to 80% by weight. For applications in which the adhesive tapes even in the uncured state have to bear a relatively high load, a proportion of 15% to 45% by weight is particularly preferred. It is possible to use one such resin or else a mixture of different resins.

Further preferably, the epoxy resins comprise at least two different epoxy resins (E-1) and (E-2), of which
a. the first epoxy resin (E-1) at 25° C. has a dynamic viscosity of less than 500 Pa*s, measured to DIN 53019-1 at a measurement temperature of 25° C. and a shear rate of 1×s⁻¹, and
b. of which the second epoxy resin (E-2) has a softening temperature of at least 45° C. or at 25° C. has a dynamic viscosity of at least 1000 Pa*s, measured to DIN 53019-1 at a measurement temperature of 25° C. and a shear rate of 1×s⁻¹,

where, in particular, the proportion of the first epoxy resin (E-1) is 10% to 90% by weight, preferably 20% to 75% by weight, and the proportion of the second epoxy resin (E-2) is 10% to 90% by weight, preferably 25% to 80% by weight, based on the totality of epoxy resins. Advantageously, the epoxy resin component consists of these two epoxy resins (E-1) and (E-2), such that the proportion of two epoxy resins (E-1) and (E-2) in the total epoxy resin adds up to 100% by weight.

Particularly good adhesives are obtained when the proportion of epoxy resin (E-2) is in the range from 40% to 80% by weight, especially 60% to 75% by weight. In a specific embodiment, the proportion of epoxy resins (E-2) having a softening temperature of at least 45° C. is at least 35% by weight, especially in the range from 40% to 70% by weight.

The cohesion of the uncrosslinked pressure-sensitive adhesives, given adequate tack nevertheless, is particularly good when the proportion of epoxy resins having a softening temperature of at least 45° C. is at least 15% by weight, especially in the range from 20% by weight to 75% by weight, based on the overall epoxy resin. Adaptation characteristics are improved when less than 55% by weight, especially between 25% by weight and 45% by weight, is present.

Epoxy resins to be used advantageously as epoxy resin or as part of the entirety of the epoxy resins are, for example, elastomer-modified epoxy resins, silane-modified epoxy resins or fatty acid-modified epoxy resins.

Elastomer-modified epoxy resins in the context of the present invention should be understood to mean epoxy resins that are especially liquid and generally of high viscosity and have an average functionality of at least two and an elastomer content of up to 50% by weight, preferably one of 5-40% by weight. The epoxy groups may be in a terminal arrangement and/or in the side chain of the molecule. The elastomeric structure component of these flexibilized epoxy resins consists of polyenes, diene copolymers and polyurethanes, preferably of polybutadiene, butadiene-styrene or butadiene-acrylonitrile copolymers.

An example of an epoxy resin modified by butadiene-acrylonitrile copolymers (nitrile rubber) is an epoxy prepolymer which is obtained by modification of an epoxy resin having at least two epoxy groups in the molecules with a nitrile rubber. The epoxy base used is advantageously a reaction product of glycerol or propylene glycol and a halogen-containing epoxy compound, such as epichlorohydrin, or the reaction product of a polyhydric phenol, such as hydroquinone, bisphenol A, and a halogen-containing epoxide. What is desirable is a reaction product formed from an epoxy resin of the bisphenol A type having two terminal epoxy groups.

For binding-on of the epoxy resins, in the case of butadiene polymers or butadiene-acrylonitrile copolymers (so-called nitrile rubbers), it is possible to include a third monomer with acid function—for example acrylic acid—in the polymerization.

The acid and the nitrile rubbers give what are called carboxy-terminated nitrile rubbers (CTBN). In general, these compounds contain acid groups not just at the ends but also along the main chain. CTBNs are supplied, for example, under the Hycar trade name by B. F. Goodrich. These have molar masses between 2000 and 5000 and acrylonitrile contents between 10% and 30%. Specific examples are Hycar CTBN 1300×8, 1300×13 or 1300×15.

The reaction proceeds correspondingly with butadiene polymers.

Reaction of epoxy resins with CTBNs affords what are called epoxy-terminated nitrile rubbers (ETBNs), which are used with particular preference for this invention. Such ETBNs are commercially available, for example, from Emerald Materials under the HYPRO ETBN name (formerly Hycar ETBN)—for example Hypro 1300X40 ETBN, Hypro 1300X63 ETBN and Hypro 1300X68 ETBN.

One example of an epoxy-terminated butadiene rubber is Hypro 2000X174 ETB.

Further examples of elastomer-modified epoxy-functional compounds are a reaction product of a diglycidyl ether of neopentyl alcohol and a butadiene/acrylonitrile elastomer having carboxyl ends (for example EPON™ Resin 58034 from Resolution Performance Products LLC), a reaction product of a diglycidyl ether of bisphenol A and a butadiene/acrylonitrile elastomer having carboxyl ends (for example EPON™ Resin 58006 from Resolution Performance Products LLC), a butadiene/acrylonitrile elastomer having carboxyl ends (for example CTBN-1300X8 and CTBN-1300X13 from Noveon, Inc., Cleveland, Ohio), and a butadiene/acrylonitrile elastomer having amine ends (for example ATBN-1300X16 and ATBN-1300X42 from Noveon, Inc.). One example of the elastomer-modified epoxy resin adduct is the reaction product of an epoxy resin based on bisphenol F and a butadiene/acrylonitrile elastomer having carboxyl ends (for example EPON™ Resin 58003 from Resolution Performance Products LLC).

The proportion of the elastomer-modified epoxy resins based on the total amount of epoxy resins may be between 0% and 100%. For bonds having particularly high bond strengths and low elongation, comparatively lower proportions—for example 0% to 15% by weight—are chosen. By contrast, adhesives with high elongation values are obtained when the proportion is greater than 40% by weight, especially greater than 60% by weight. For many applications, a balanced ratio between bond strength and elongation is desired. Preference is given here to proportions between 20-60% by weight, especially 30-50% by weight. According to the profile of requirements, it may also be advantageous to create adhesives with a proportion of up to 100%.

Further suitable representatives used for the epoxy resins may very advantageously be silane-modified epoxy resins. It is possible here for a single silane-modified epoxy resin or for two, three or even more silane-modified epoxy resins to be present in the curable composition. The curable composition may be limited to the silane-modified epoxy resin(s) as curable reactive resins. As well as the epoxy resin(s), it is also possible for further, non-silane-modified epoxy resins to be present—for example, elastomer-modified, especially nitrile rubber-modified—epoxy resins and/or fatty acid-modified epoxy resins, as individually set out in detail in this specification, and/or else reactive resins that are not epoxy resins.

If a single silane-modified epoxy resin is present, this may especially be selected from the silane-modified epoxy resins described as preferred hereinafter. If multiple silane-modified epoxy resins are present, advantageously at least one of the epoxy resins is one of the compounds described hereinafter as preferred silane-modified epoxy resins. Further preferably, all silane-modified epoxy resins are those as described as preferred hereinafter.

The chemical modification of epoxy resins can be utilized for control of the properties of adhesives. Modified epoxy resins of the invention are especially selected from silane-modified epoxy resins. Silane group-modified epoxy resins are those epoxy resins to which one or more silane groups are chemically bonded.

In principle, there are different ways of binding silane groups chemically to epoxy resins.

In a preferred procedure, the epoxy resin used is a silane-modified epoxy resin obtainable by dealcoholizing condensation reaction between a bisphenol epoxy resin and a hydrolyzable alkoxysilane. Such epoxy resins are described, for example, in EP 1114834 A, the disclosure content of which is hereby incorporated into the present specification by reference.

The bisphenol epoxy resin may advantageously be chosen such that it has an epoxy equivalent weight of more than 180 g/eq, and preferably of less than 5000 g/eq. For epoxy resins or epoxy crosslinkers, the epoxy equivalent weight (abbreviation: EEW) is a characteristic and important parameter. According to DIN EN ISO 3001:1999-11, the epoxy equivalent weight indicates the amount of the substance in question in the solid state in grams that is bound per epoxy group. Preference is given to using epoxy resins having an EEW>180 g/eq, since there may otherwise be insufficient hydroxy groups for the condensation reaction with the alkoxysilanes.

In a preferred manner, the bisphenol epoxy resin used for reaction with the hydrolyzable alkoxysilane comprises compounds conforming to the following formula:

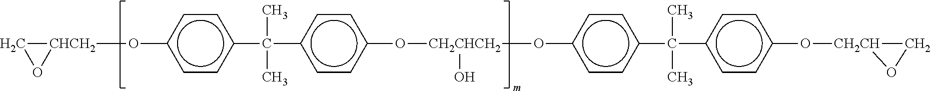

In general, this is a mixture of corresponding compounds of the bisphenol epoxy resin formula above with varying repeat number m of the unit in the square brackets. The bisphenol epoxy resin here is especially chosen such that the average of m is 0.07 to 16.4, i.e. the number-average molar masses are between about 350 g/mol and 4750 g/mol.

In a further preferred manner, the hydrolyzable alkoxysilane is either a compound conforming to the general formula

R^{X}ₚSi(OR^{Y})₄₋ₚ

where p is 0 or 1, R^{X} is a C—C alkyl group, an aryl group or an unsaturated aliphatic hydrocarbyl group that may have a functional group bonded directly to a carbon atom, RY represents a hydrogen atom or a lower alkyl group, and the RY radicals may be the same or different, or the hydrolyzable alkoxysilane is a partial condensate of the compound stated. The functional group bonded directly to a carbon atom may, for example, be a vinyl group, mercapto group, epoxy group, glycidoxy group etc. The lower alkyl group may, for example, be an unbranched or branched alkyl group having 6 or fewer carbon atoms.

Examples of the hydrolyzable alkoxysilane include tetramethoxysilane, tetraethoxysilane, tetrapropoxysilane, tetraisopropoxysilane, tetrabutoxysilane and similar tetraalkoxysilanes; methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, vinyltrimethoxysilane, vinyltriethoxysilane, 3-glycidoxypropyltrimethoxysilane, 3-glycidoxypropyltriethoxysilane, 3-mercaptopropyltrimethoxysilane, 3-mercaptopropyltriethoxysilane, phenyltrimethoxysilane, phenyltriethoxysilane, 3,4-epoxycyclohexylethyltrimethoxysilane, 3,4-epoxycyclohexylethyltriethoxysilane and similar trialkoxysilanes; or partial condensates of these compounds.

Among these compounds, preference is given to tetramethoxysilane, tetraethoxysilane and similar tetraalkoxysilanes or partial condensates thereof. Particular preference is given to poly(tetramethoxysilane), which is a partial condensate of tetramethoxysilane, represented by the formula

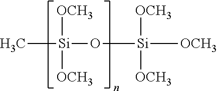

(where the average of n is 1 to 7). The poly(tetramethoxysilane) represented by the formula above may contain a molecule in which n is 0, provided that the average of n is 1 or greater. The number-average molar mass of the poly(tetramethoxysilane) is preferably about 260 to about 1200. In addition, poly(tetramethoxysilane) is non-toxic, by contrast with tetramethoxysilane.

In a further preferred procedure, the epoxy resin used is a silane-modified epoxy resin obtainable by modifying bisphenol diglycidyl ether with alkoxysilanes bearing an epoxy group. Such silane-modified epoxides and the preparation process therefor are described in U.S. Pat. No. 8,835,574 A, the disclosure content of which is likewise incorporated into this specification by reference. In the process outlined therein, the epoxyalkoxysilane is partly hydrolyzed and partly condensed in the presence of water. In a second step, a bisphenol diglycidyl ether is added and bound to the partial siloxane condensate.

In a further synthesis route for silane-modified epoxy resins usable advantageously in accordance with the invention, alkoxysilanes containing an isocyanate group are bound to the aliphatic hydroxyl groups to form a urethane group.

The proportion of the silane-modified epoxy resins based on the total amount of epoxy resins in the curable composition may be between 0 and 100%. To reduce peel increase on certain siliconized liners, comparatively lower proportions—for example 5% to 25% by weight—are chosen. For balanced performance even after storage under hot and humid conditions, proportions between 10% to 50% by weight, especially 20% to 40% by weight, have been found to be excellent.

Epoxy resins used in accordance with the invention may also very advantageously be fatty acid-modified epoxides.

Fatty acid-modified epoxy resins used are preferably epoxy resin esters, also called epoxy esters, i.e., the esterification products of epoxy resins with saturated or unsaturated fatty acids.

It is possible for a single fatty acid-modified epoxy resin or for two, three or even more fatty acid-modified epoxy resins to be present in the curable composition. The curable composition may be limited to the fatty acid-modified epoxy resin(s) as curable reactive resins. As well as the fatty acid-modified epoxy resin(s), it is also possible for further, non-fatty acid-modified epoxy resins to be present—for example elastomer-modified, especially nitrile rubber-modified—epoxy resins and/or silane-modified epoxy resins, as individually set out in detail in this specification, and/or else reactive resins that are not epoxy resins.

If a single fatty acid-modified epoxy resin is present, this may especially be selected from the fatty acid-modified epoxy resins described as preferred hereinafter. If multiple fatty acid-modified epoxy resins are present, advantageously at least one of the epoxy resins is one of the compounds described hereinafter as preferred fatty acid-modified epoxy resins. Further preferably, all fatty acid-modified epoxy resins are those as described as preferred hereinafter.

The chemical modification of epoxy resins can be utilized for control of the properties of adhesives. Modified epoxy resins of the invention are especially selected from fatty acid-modified epoxy resins. Fatty acid group-modified epoxy resins are those epoxy resins to which one or more fatty acids are chemically bound, especially by esterification reactions.

The epoxy resin base used for the fatty acid-modified epoxy resins, especially epoxy esters, may especially be epoxy resins of the bisphenol A/epichlorohydrin type according to the general formula already introduced above

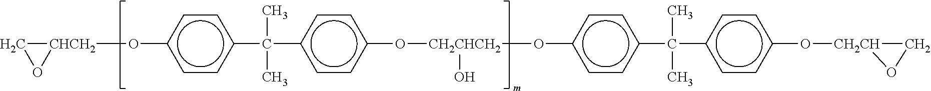

The basis chosen for the fatty acid-modified epoxides is the bisphenol epoxy resin of the formula above, chosen especially such that the average of m=0.07 to 16.4, i.e., the number-average molar masses are between about 350 g/mol and 4750 g/mol. Particular preference is given to using compounds of the formula 1 with m=2.3 to m=10 in pure form (with integer values for m) or in the form of mixtures (corresponding to number-average molar masses between about 1000 and about 3000 g/mol).

Not only the terminal epoxy groups but also the secondary hydroxy groups of bisphenol-based epoxy resins can react with fatty acids. The esterification typically first opens up the two epoxy rings, followed by the reaction of the hydroxy groups.

Each epoxy group here is equivalent to 2 hydroxy groups since the reaction of an acid group with an epoxide gives rise to a 8-hydroxy ester. These 8-hydroxy groups can also react with fatty acids. The preparation is typically effected at temperatures of 240-260° C. under protective gas atmosphere, preferably under azeotropic conditions, in order to remove the water of reaction released. Optionally, the reaction is accelerated by addition of catalysts, for example calcium or zinc soaps, of for example fatty acids such as stearic acid. According to the desired property, 40% to 80% of the functional groups available in the epoxy resin are reacted with fatty acids.

An epoxy resin of the n type (corresponding to the number of free OH groups along the chain) can theoretically bind an average of not more than n+4 fatty acid molecules per epoxy resin molecule (esterification level 100%). Accordingly, in the case of epoxy resin esters, the “oil length” is defined as follows:

short-oil: esterification level 30-50%;

medium-oil: esterification level 50-70%;

long-oil: esterification level 70-90%.

Examples of fatty acids of good suitability in accordance with the invention for the esterification include coconut oil fatty acid, ricinene fatty acid (fatty acid of dehydrated castor oil), linseed oil fatty acid, soybean oil fatty acid or tall oil fatty acid.

Further fatty acids that are advantageous in accordance with the invention are α-linolenic acid, stearidonic acid, eicosapentaenoic acid, docosahexaenoic acid, linoleic acid, γ-linolenic acid, dihomo-gamma-linolenic acid, arachidonic acid, docosa-7,10,13,16-tetrayn-1-oic acid, palmitoleic acid, vaccenic acid, oleic acid, elaidic acid, gadoleic acid, 13-eicosenoic acid, erucic acid, nervonic acid, stearic acid, Mead's acid.

Also usable are dimers and oligomers of unsaturated fatty acids, for example the dimers of tall oil fatty acids.

The proportion of the fatty acid-modified epoxy resins based on the total amount of epoxy resins in the curable composition may be between 0 and 100%. For bonds with especially high bond strengths even at high temperatures, comparatively lower proportions—for example 5% to 25% by weight—are chosen. For good performance even after storage under hot and humid conditions, proportions between 10% to 50% by weight, especially 20% to 40% by weight, have been found to be excellent.

Preparation Processes

The adhesives used in accordance with the invention can in principle be prepared by the processes known to the person skilled in the art.

A very gentle process by which it is possible to process even raw materials that are difficult to process, such as non-thermoplastic elastomers—for example nitrile rubbers—is extrusion, especially using a planetary roll extruder. It is possible thereby even to incorporate the sensitive components of the curable composition, such as reactive resins and hardeners, without prior reaction of these components or other problems in the process. Such a prior reaction would already cure or at least partly cure the adhesive tape and be at odds with the aim of a storable transportable adhesive tape which is to be cured only after application.

Planetary roll extruders as a continuously operating unit have been known for some time and were first used in the processing of thermoplastics, for example PVC, where they were used mainly for charging of the downstream units, for example calenders or roll systems. Their advantage of high surface renewal for material and heat exchange, with which the energy introduced via friction can be removed rapidly and effectively, and of short residence time and narrow residence time spectrum, has allowed their field of use to be broadened recently to processes including compounding processes that require a mode of operation with exceptional temperature control.

Planetary roll extruders consist of multiple parts, namely a revolving central spindle, a housing that surrounds the central spindle at a distance and has inner teeth and planetary spindles that revolve in the cavity between central spindle and internally toothed housing like planets around the central spindle. Where reference is made hereinafter to inner teeth of the housing, this also includes a multipart housing with a bushing that forms the inner teeth of the housing. In the planetary roll extruder, the planetary spindles mesh both with the central spindle and with the housing that has teeth on the inside. At the same time, the planetary spindles slide against a stop ring by their end that points in conveying direction. Planetary roll extruders, compared to all other designs of extruder, have extremely good mixing action but much lower conveying action.

Planetary roll extruders exist in various designs and sizes according to the manufacturer. According to the desired throughput, the diameters of the roll cylinders are typically between 70 mm and 400 mm.

Planetary roll extruders generally have a filling section and a compounding section.

The filling section, generally corresponding to a filling zone, consists of a conveying screw onto which all the solid-state components—in the present case especially the non-thermoplastic elastomers and any further components—are metered continuously. The conveying screw then transfers the material to the compounding section. The region of the filling section with the screw is preferably cooled in order to avoid caking of material on the screw. But there are also embodiments without a screw section, in which the material is applied directly between central and planetary spindles. However, this is of no significance for the efficacy of the process. The central spindle can preferably also be cooled.

The compounding section typically consists of a driven central spindle and several planetary spindles that rotate around the central spindle within a roll cylinder having internal helical gearing. The speed of the central spindle and hence the peripheral velocity of the planetary spindles can be varied and is thus an important parameter for control of the compounding process. The compounding portion may be formed by a single compounding cell or by a sequence of multiple, mutually separated compounding zones, separated especially by stop rings and possibly additional injection or dispersing rings. The number and arrangement of the planetary spindles may vary from compounding zone to compounding zone. Typically, the compounding portion will preferably consist at least of two, but more preferably of three or four, coupled roll cylinders, with each roll cylinder having one or more separate temperature control circuits.

The surrounding housing has a jacket, in a contemporary design. The inner shell is formed by a bushing provided with internal teeth. Provided between inner shell and outer shell is the important cooling of the planetary roll extruder.

The planetary spindles do not require guiding in circumferential direction. The teeth ensure that the separation of the planetary spindles in circumferential direction remains the same. This can be referred to as self-guiding.

The materials are circulated between the central and planetary spindles, i.e., between planetary spindles and the helical gearing of the roll section, such that the materials are dispersed under the influence of shear energy and external temperature control to give a homogeneous compound.

The number of planetary spindles that rotate in each roll cylinder can be varied and hence adapted to the demands of the process. The number of spindles affects the free volume within the planetary roll extruder and the residence time of the material in the process, and additionally determines the size of the area for heat and material exchange. The number of planetary spindles affects the compounding outcome via the shear energy introduced. Given a constant roll cylinder diameter, it is possible with a greater number of spindles to achieve better homogenization and dispersion performance, or a greater product throughput. For achievement of a good ratio of compounding quality to product rate, at least half or even at least 3/4 of the possible number of planetary spindles should preferably be used.

The maximum number of planetary spindles that can be installed between the central spindle and roll cylinder is dependent on the diameter of the roll cylinder and on the diameter of the planetary spindles used. In the case of use of greater roll diameters as necessary for achievement of throughputs on the production scale, or smaller diameters for the planetary spindles, the roll cylinders can be equipped with a greater number of planetary spindles. Typically, up to seven planetary spindles are used in the case of a roll diameter of D=70 mm, while ten planetary spindles, for example, can be used in the case of a roll diameter of D=200 mm, and 24, for example, in the case of a roll diameter of D=400 mm.

It will be appreciated that each roll cylinder may be equipped differently with regard to the number and type of planetary spindles and hence be matched to the respective formulation-related and process-related demands.

According to the invention, it has been possible to provide storage-stable curable epoxy-based compositions that are of excellent suitability as adhesives in adhesive tapes and with which it is suitable to create even very thick adhesive tapes. The products produced have very good adhesion, especially to glass surfaces. By virtue of the components chosen, it has been possible to reduce or entirely avoid solubility of the curing agents used in the other components, which affords very storage-stable products that have good transportability and storability and ensure their full bonding performance even on customer employment—even after prolonged storage time.

The curing of the adhesives or adhesive tapes of the invention after application can advantageously take place at temperatures between 120° C. and 200° C. for 10 to 120 minutes. The exact conditions are guided by the hardener used and any accelerator used and the amount of accelerator used. Typically, accelerators are used between 0.5 phr and 5 phr, with phr relating to the amount of epoxy resins used. Illustrative curing conditions are 30 minutes at 180° C., 30 minutes at 160° C., 35 minutes at 145° C., 60 minutes at 130° C., 120 minutes at 120° C.

According to the invention, it is possible to create very thick adhesive tapes. The presentation of intrinsically highly viscous adhesives in the form of stable films—for instance by the embedding of the reactive adhesive into a polymeric film former matrix—with the adhesives of the invention opens up access to very storage-stable adhesive films in a wide variety of dimensions.

For instance, it is possible to offer adhesive films in very thin form—for example from a thickness of a few μm—through customary adhesive tape thicknesses, for instance with adhesive layers of thickness 25 μm up to 100 μm—for instance 50 μm-thick adhesive layers, up to adhesive tapes having very thick adhesive layers of more than 100 μm, preferably of more than 200 μm, even of 300 μm or more, 500 mm or more, 1 mm or more, up to adhesive layers in the region of a few millimeters and even centimeters, not only as single-layer adhesive films (adhesive transfer tapes) but also as single- or double-sided multilayer adhesive tapes, including those with a carrier material.

Reference Methods

The respective parameter data reported in this specification relate, unless otherwise specified or indicated individually, to the following reference determination methods:

Viscosity

A measure of the flowability of the fluid coating material is dynamic viscosity. Dynamic viscosity is determined to DIN 53019. A viscosity of less than 108 Pas is described as fluid. Viscosity is measured in a cylindrical rotary viscometer with a standard geometry according to DIN 53019-1 at a measurement temperature of 23° C. and a shear rate of 1 s-1.

Molar Mass

Figures for number-average molar mass Mn or for weight-average molar mass Mw are based on measurement by means of gel permeation chromatography (GPC) as follows:

The eluent used was THF (tetrahydrofuran) with 0.1% by volume of trifluoroacetic acid. The measurement was made at 25° C. The precolumn used was PSS-SDV, 5μ, 10³ Å, ID 8.0 mm×50 mm. Separation took place using the columns PSS-SDV, 5μ, 10³ and also 105 and 106, each with ID 8.0 mm×300 mm. The sample concentration was 4 g/I; the flow rate was 1.0 ml per minute. Measurement was made against polystyrene standards.

Softening Temperatures of Polymers/Resins

The softening temperature, unless stated otherwise individually, is determined by the relevant methodology, which is known as the Ring and Ball method and is standardized in ASTM E28.

The softening temperature is determined using a Herzog HRB 754 Ring and Ball tester. The samples to be analyzed—for instance the resin or elastomer—are first finely crushed by mortar and pestle. The resulting powder is introduced into a brass cylinder open at the base (internal diameter in the upper part of the cylinder 20 mm, diameter of the base opening of the cylinder 16 mm, height of the cylinder 6 mm) and melted on a hot stage. The filling volume is chosen such that the sample after melting fills the cylinder fully without excess.

The resulting specimen together with the cylinder is placed into the sample holder of the HRB 754. The equilibration bath is filled with glycerol if the softening temperature is between 50° C. and 150° C. At lower softening temperatures, it is also possible to work with a water bath. The test balls have a diameter of 9.5 mm and weigh 3.5 g. In accordance with the HRB 754 procedure, the ball is arranged above the test specimen in the equilibration bath and placed onto the test specimen. 25 mm beneath the base of the cylinder is a collector plate, and 2 mm above the latter is a light barrier. During the measurement process, the temperature is increased at 5° C./min. In the temperature range of the softening temperature, the ball begins to move through the base opening of the cylinder until it finally comes to rest on the collector plate. In this position, it is detected by the light barrier and the temperature of the equilibration bath at this time is registered. A double determination takes place. The softening temperature is the average from the two individual measurements.

Static Glass Transition Temperature

The static glass transition temperature (Tg) is determined via Differential Scanning calorimetry to DIN 53765:1994-03. For this, approximately 7 mg of the sample are weighed out precisely into an aluminum crucible and then placed inside the instrument (instrument: DSC 204 F1, from Netzsch). An empty crucible serves as reference. Then two heating curves are recorded with a heating rate of 10 K/min. The figures for the glass transition temperature Tg pertain to the DIN 53765:1994-03 glass transformation temperature Tg of the second heating curve, unless stated otherwise individually.

Further reference methods are apparent from the test methods in the Experimental Section.

### EXPERIMENTAL SECTION

Shelf Life

The shelf life (SL) of the (uncured) copolymers was determined via DSC. For this purpose the heat of reaction of a fresh mixture of Epikote828LVEL with 7.03% of dicyandiamide (Dyhard 100SF) and, unless otherwise noted, 5 phr of the copolymer under test is determined (ΔH_{fresh}) and compared with the residual heat of reaction of the storage at 60° C. for 10 d (ΔH_{10d60}).

SL=ΔH_{10d60}/ΔH_{fresh}

Shelf life is satisfactory in the sense of the invention at SL>85%, more particularly >95%, and is denoted in the experiments by “pass”.

Tpeak

Tₚₑₐₖ is the temperature of the curing curve, determined by DSC, from the shelf life measurement that is achieved at the maximum of the exothermic reaction signal.

Raw materials used:

List of monomers used in preparing the illustrative polymers

a) High-Tg Monomers

“TUEMA” 2-(3-toloidylureido)ethyl methacrylate (homopolymer Tg˜137° C.)

“PhMal” n-phenylmaleimide (homopolymer Tg˜325° C.)

“MMA” methyl methacrylate (homopolymer Tg˜105° C.)

“S” styrene (homopolymer Tg˜100° C.)

b) Monomers having tertiary aromatic amine side groups

“Vlm” vinylimidazole (homopolymer Tg˜131° C.)

“ImEMA” imidazoleethyl methacrylate (homopolymer Tg˜60° C.)

“ImEUr-M” imidazoleethylurethane methacrylate (homopolymer Tg˜32° C.)

“2M-ImEMA” 2-methylimidazoleethyl methacrylate (homopolymer Tg˜76° C.)

“DMAP-M” N-methyl-N-(4-pyridylamino)ethyl methacrylate (homopolymer Tg˜29° C.)

PMI (TCI Chemicals, not purified before use), MMA (Sigma Aldrich, distilled before use), S (Merck, distilled before use) and Vim (Sigma-Aldrich, not purified before use).

Preparation of the Noncommercial Monomers p-Toluidineureaethyl Methacrylate (TUEMA)

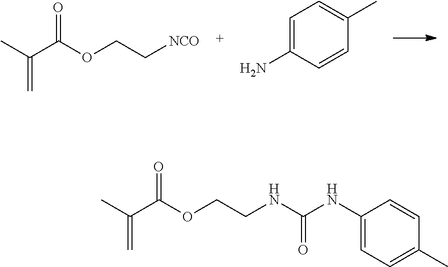

A two-neck flask was charged under a nitrogen atmosphere with 0.760 g (7.09 mmol) of p-toluidine and 0.0365 g (0.325 mmol) of 1,4-diazabicyclo[2.2.2]octane in 10 ml of tetrahydrofuran. The solution was admixed dropwise with 1.00 ml (7.08 mmol) of 2-isocyanatoethyl methacrylate. The reaction mixture was subsequently stirred at 60° C. for 3 h and the solvent was removed under reduced pressure. The resulting crude product was dissolved in DCM, washed once with water and twice with saturated sodium chloride solution, the solution was dried using magnesium sulfate, and the solvent was subsequently removed under reduced pressure. Purification by column chromatography (silica gel; nH:EE 2:1 to 1:1) gave 1.60 g (6.10 mmol; 86%) of a beige solid.

Imidazoleethyl Methacrylate (ImEMA)

1)

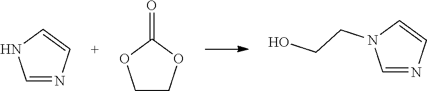 [SMILES: c1c[nH]cn1 ; O=C1OCCO1 ; OCCn1ccnc1]

In a two-neck flask with reflux condenser, 8.01 g (0.118 mol) of imidazole and 16.0 g of ethylene carbonate (0.182 mol) were dissolved in 30 ml of toluene and heated under reflux for 6 h. After cooling to room temperature, the toluene phase was taken off and 11 ml of concentrated hydrochloric acid were added with water-bath cooling. The solution was washed three times with DCM and the aqueous phase was adjusted to a pH of 12 by addition of potassium carbonate. The aqueous phase was extracted with dichloromethane and the solution obtained was dried using magnesium sulfate, and the solvent was subsequently removed under reduced pressure. This gave 6.14 g (0.0548 mol; 47%) of the product in the form of an oily brown liquid.

2)

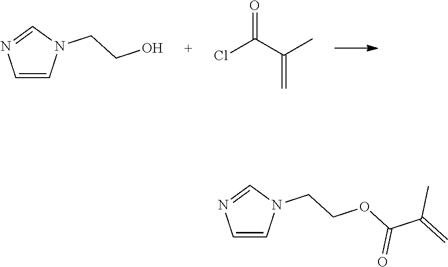

In a two-neck flask under a nitrogen atmosphere, a solution of 1.92 g (17.1 mmol) of hydroxyethylimidazole, 2.80 ml of triethylamine (20.2 mmol) and 10 mg of phenothiazine in 8 ml of THF was admixed slowly dropwise in an ice bath with a solution of 2.00 ml (20.5 mmol) of methacryloyl chloride in 4 ml of THF. The solution was allowed to warm to room temperature overnight and the solid form was subsequently removed by filtration. The solvent was subsequently removed under reduced pressure. Purification by column chromatography (silica gel) using DCM:MeOH 100:3 gave 2.15 g (11.9 mmol; 70%) of a yellowish liquid.

2-Methylimidazoleethyl Methacrylate (2M-ImEMA)

1)

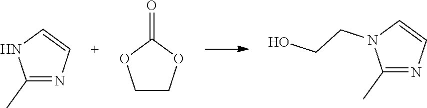

In a two-neck flask with reflux condenser, 5.00 g (0.0609 mol) of 2-methylimidazole and 8.34 g of ethylene carbonate (0.0947 mol) were dissolved in 20 ml of toluene and heated under reflux for 5 h 30 min. After cooling to room temperature, the toluene phase was taken off and 11 ml of concentrated hydrochloric acid were added with water-bath cooling. The solution was washed three times with DCM and the aqueous phase was adjusted to a pH of 12 by addition of potassium carbonate. The aqueous phase was extracted with dichloromethane and the solution obtained was dried using magnesium sulfate, and the solvent was subsequently removed under reduced pressure. This gave 4.58 g (0.0363 mol; 60%) of the product in the form of an oily brown liquid.

2)

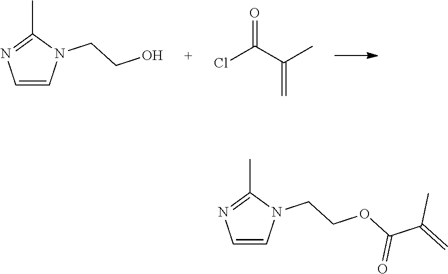

In a two-neck flask under a nitrogen atmosphere, a solution of 3.21 g (25.4 mmol) of PRO40, 4.30 ml of triethylamine (31.0 mmol) and 10 mg of phenothiazine in 13 ml of THF was admixed slowly dropwise in an ice bath with a solution of 3.03 ml (31.0 mmol) of methacryloyl chloride in 7 ml of THF. The solution was allowed to warm to room temperature overnight and the solid form was subsequently removed by filtration. The solvent was subsequently removed under reduced pressure. Purification by column chromatography (silica gel) using DCM:MeOH 100:3 gave 1.25 g (6.04 mmol; 24%) of a yellowish liquid.

Methylaminopyridineethyl Methacrylate (DMAP-M)

1)

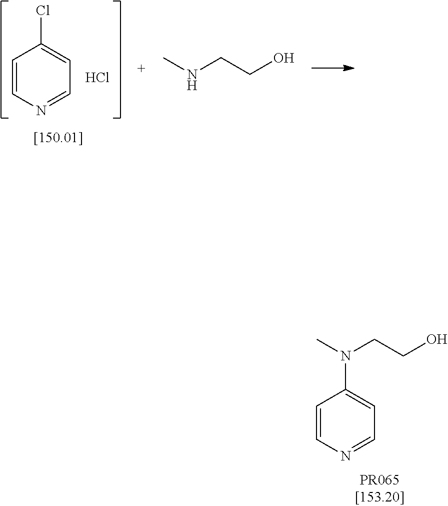

In a two-neck flask under a nitrogen atmosphere, 7.51 g (50.1 mmol) of 4-chloropyridine hydrochloride were dissolved in 50.0 ml (622 mmol) of 2-methylaminoethanol and stirred at 120° C. for 14 h. The 2-methylaminoethanol was subsequently distilled off and the residue remaining was dissolved in ethyl acetate and washed three times with saturated sodium chloride solution. Sodium hydroxide was added to the collective aqueous phases, which were extracted three times with ethyl acetate. The collected organic phases were dried using magnesium sulfate, the solvent was removed under reduced pressure, and the crude product was purified by column chromatography (silica gel, DCM:MeOH 10:1 to 10:2). This gave 5.14 g (33.6 mmol; 67%) of a yellow crystalline solid.

2)

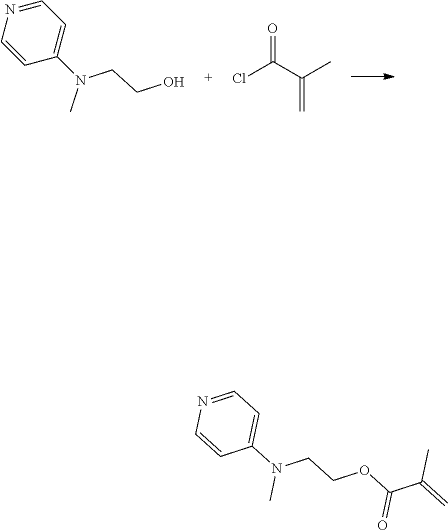

In a two-neck flask under a nitrogen atmosphere, a solution of 2.01 g (13.2 mmol) of PR065, 2.20 ml of triethylamine (15.9 mmol) and 10 mg of phenothiazine in 15 ml of THF was admixed slowly dropwise in an ice bath with a solution of 1.54 ml (15.8 mmol) of methacryloyl chloride in 10 ml of THF. The solution was allowed to warm to room temperature overnight and the solid form was subsequently removed by filtration. The solvent was subsequently removed under reduced pressure. Purification by column chromatography (silica gel; DCM:MeOH 100:1) gave 1.62 g (7.35 mmol; 55%) of a yellowish liquid.

Imidazoleethylurethane Methacrylate (ImEUr-M)

1)

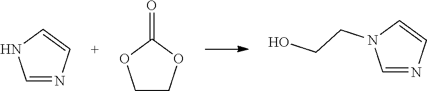 [SMILES: c1c[nH]cn1 ; O=C1OCCO1 ; OCCn1ccnc1]

In a two-neck flask with reflux condenser, 8.01 g (0.118 mol) of imidazole and 16.0 g of ethylene carbonate (0.182 mol) were dissolved in 30 ml of toluene and heated under reflux for 6 h. After cooling to room temperature, the toluene phase was taken off and 11 ml of concentrated hydrochloric acid were added with water-bath cooling. The solution was washed three times with DCM and the aqueous phase was adjusted to a pH of 12 by addition of potassium carbonate. The aqueous phase was extracted with dichloromethane and the solution obtained was dried using magnesium sulfate, and the solvent was subsequently removed under reduced pressure. This gave 6.14 g (0.0548 mol; 47%) of the product in the form of an oily brown liquid.

2)

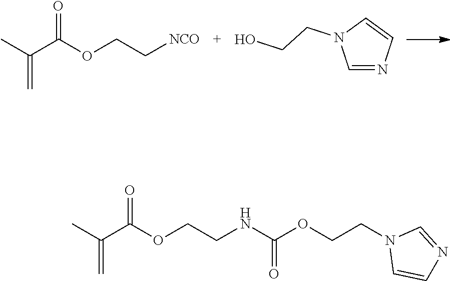

A two-neck flask was charged under a nitrogen atmosphere with 1.59 g (14.2 mmol) of hydroxethylimidazole and 0.0801 g (0.714 mmol) of 1,4-diazabicyclo[2.2.2]octane in 30 ml of tetrahydrofuran. The solution was admixed dropwise with 2 ml (14.2 mmol) of 2-isocyanatoethyl methacrylate. The reaction mixture was subsequently stirred at 65° C. for 6 h and the solvent was removed under reduced pressure. Purification by column chromatography (silica gel) DCM:MeOH 100:1 to 100:5) gave 2.89 g (11.1 mmol; 86%) of a beige solid.

Polymerization

General protocol:

The respective monomer compositions, 5 mol % of AIBN and chain transfer agent (mercaptoethanol, where used) were dissolved in DMF (30% strength solution) and the solutions were each flushed with argon for 3 min. the polymerization was carried out subsequently in an oil bath at 65° C. for 22 h. Polymers obtained were precipitated from diethyl ether and dried under reduced pressure at 60° C.

List of Illustrative Polymers

| | | | Monomer | Mercaptoethanol/ | Mn, | Tg/ |
|---|---|---|---|---|---|---|
| | Monomers | Composition | feed | mol % | Mw | ° C. |
| B1 | TUEMA:Vlm | 52:48 | 1:1 | 2 | 5500, | 135 |
| | | | | | 10800 | |
| B2 | TUEMA:ImEMA | 56:44 | 1:1 | | 84000, | 117 |
| | | | | | 115000 | |
| B3 | TUEMA:ImEMA | 54:46 | 1:1 | 5 | 1700, | 83 |
| | | | | | 2100 | |
| B4 | TUEMA:ImEMA:PhMal | 30:60:10 | 27:63:10 | | 1500, | 114 |
| | | | | | 1800 | |
| B5 | TUEMA:ImEMA:PhMal | 36:54:10 | 36:54:10 | | 3500, | 119 |
| | | | | | 9600 | |
| B6 | TUEMA:ImEMA:PhMal | 47:43:10 | 45:45:10 | 5 | 4200, | 116 |
| | | | | | 12600 | |
| B7 | TUEMA:ImEMA | 80:20 | 4:1 | 2 | n.b. | 119 |
| B8 | MMA:ImEMA:PhMal | 21:49:30 | 20:50:30 | | 1500, | 113 |
| | | | | | 1700 | |
| B9 | MMA:ImEMA | 51:49 | 1:1 | | | 91 |
| B10 | TUEMA:2M-ImEMA | 50:50 | 1:1 | | | 129 |
| B11 | TUEMA:DMAP-M | 56:44 | 1:1 | | 2200, | 118 |
| | | | | | 4800 | |
| V3 | ImEMA | 100 | 1 | | <1000 | 60 |

TABLE 1

| Name | SL | T peak |
|---|---|---|
| B1 | pass | 166 |
| B2 | pass | 156 |
| B3 | pass | 155 |
| B4 | pass | 152 |
| B5 | pass | 152 |
| B6 | pass | 153 |
| B7 | pass | 167 |
| B8 | pass | 154 |
| B9 | pass | 151 |
| B10 | pass | 156 |
| B11 | pass | 171 |
| V1 | pass | 172 |

Table 1 reports the Tpeak temperatures of the respective polymers, along with an indication of whether they gained a pass or a fail in the storage test.

The activating effect of the nitrogen-containing aromatic heterocyclic group is particularly effective, surprisingly, when it is not bonded directly on the polymer backbone. This becomes clear in the comparison of B1 and B2. In fact both accelerators are storage-stable and exhibit an accelerating effect. The peak temperature of B2, however, is 10° C. lower. Without being tied to any theory, it is assumed that the decoupling from the polymer backbone by at least 2, preferably 4, atoms means that on exceedance of the Tg the amino groups are more readily accessible for the reactive resin.

B4-B7 are examples of the invention with different amounts of monomers B in the polymer (20%-60%). The examples are storable and exhibit highly activating properties (B4-B6 Tₚₑₐₖ=152/153° C., B7 Tₚₑₐₖ=167° C.). The activating property of B7, with only 20% of monomer B, appears initially to be relatively weak. In the DSC experiment, however, the same amount of accelerator (5 phr) was used. Owing to the lower amount in the copolymer, therefore, there are fewer accelerating groups present in the curing tests. This can be counteracted by simply increasing the amount of accelerator. Surprisingly the activating effect does not rise in line with the rising amount of monomer B, as is readily apparent not only in the range of the invention between 45% and 60% (B4-B6) but also in the counter—example V1, which consists 100% of ImEMA. Without being tied to any theory, it is assumed that where the fractions of ImEMA are too high, there is a sharp reduction in the solubility, which is introduced by way of the high-Tg monomers (monomers A), and so the accelerating monomers B are not available in sufficient form.

With commercially available high-Tg monomers as well, such as MMA and n-Phenylmalimide, accelerator polymers of the invention can be obtained. This is shown with B8 and B9.

Imidazoles have emerged as being particularly reactive and at the same time highly storable (B2 unsubstituted imidazole, B10 methylimidazole). Other tertiary aromatic amino groups as well, however, have an accelerating effect and can nevertheless be used for highly storable epoxy resin adhesives. This is shown illustratively in B11 with a tertiary aromatic amine comparable to DMAP.

Use in Reactive Pressure-Sensitive Adhesive

Raw Materials Used

Breon N41H80 Hot-polymerized nitrile-butadiene rubber with an acrylonitrile fraction of 41 wt % from Zeon Chemicals (London, UK). Mooney viscosity as per technical datasheet 70-95.

PolyDis PD3611 Nitrile rubber-modified epoxy resin based on bisphenol-F diglycidyl ether with an elastomer content of 40 wt % and a weight per epoxide of 550 g/eq from Schill+Seilacher “Struktol”. Viscosity at 25° C. of 10000 Pa s.

PolyDis PD3691 Nitrile rubber-modified epoxy resin based on bisphenol-A diglycidyl ether with an elastomer content of 5 wt % and a weight per epoxide of 205 g/eq from Schill+Seilacher “Struktol”. Viscosity at 25° C. of 300 Pa s.

Dyhard 100S Latent hardener from AlzChem for epoxy systems, consisting of micronized dicyandiamide in which 98% of the particles are smaller than 10 μm.

Dyhard UR500 Latent, dimethylurea-based accelerator for epoxy systems, in which 98% of the particles are smaller than 10 μm.

Adhesives

Adhesive composition K1 Adhesive composition KV1

| K1 | | KV1 | |
|---|---|---|---|
| Parts by | | Parts by | |
| weight | Raw material | weight | Raw material |
| 15 | Breon N41H80 | 15 | Breon N41H80 |
| 60 | PD3611 | 60 | PD3611 |
| 22 | PD3691 | 22 | PD3691 |
| 3 | Aerosil R202 | 3 | Aerosil R202 |
| 4.14 | Dyhard 100S | 4.14 | Dyhard 100S |
| 0.82 | Polymer B2 | 0.41 | Dyhard UR500 |

| | K1 | KV1 |
|---|---|---|
| Peel adhesion | 15 | 16 |
| (steel)/N cm⁻¹ | | |
| Bond strength/ | 15.3 | 17.2 |
| MPa (15 min | | |
| 180° C.) | | |
| 30 min 180° C. | 20.4 | 19.6 |
| 40 min 180° C. | 21.9 | 22.7 |
| SL₄₀/% | 100 | 41 |
| SL₈₀/% | 99 | 0 |

K1 in comparison to KV1 with the commercial dimethylurea accelerator Dyhard UR500 shows that the accelerators of the invention (polymer B2) achieve comparable bond strengths on curing. However, the shelf life of the two adhesives is very different. K1 shows no change in the DSC heat of reaction (SL₄₀=SL₆₀=100%) both on storage of 40° C. to 10 d and at 60° C. for 10 d.

In contrast to this, the adhesive with the commercial urea accelerator KV1 has already undergone 59% reaction (SL₄₀=41%) after storage at 40° C. for 10 d, and on storage of 60° C. is completely cured after 10 d.

1. A process for the radical polymerization for the preparation of a copolymer, comprising or consisting of the polymerizing of
at least one monomer A which contains at least one unsaturated —C═C— double bond and has a T_{g}≥0° C., determined from the homopolymer of the monomer A by means of DSC measurement;
at least one monomer B which contains an aromatic heterocyclic group containing at least one nitrogen atom in the ring and which further contains at least one unsaturated —C═C— double bond; and
optionally at least one monomer C which contains at least one unsaturated —C═C— double bond that is different from monomer A and B;
in the presence of at least one radical initiator and optionally of at least one chain transfer agent; where the at least one monomer A is contained in at least 30 mol % based on the total monomers of the copolymer.

2. The process as claimed in claim 1, characterized in that
i) the at least one monomer A has a molecular weight of less than 1000 g/mol; and/or
ii) the at least one monomer A comprises no nitrogen-containing aromatic heterocyclic group; and/or
iii) the at least one monomer A is selected from one of the following groups iiia) to iiid),
iiia) acenaphthylene, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, stearyl acrylate, vinyl acetate, n-butyl methacrylate, methyl acrylate, 2-phenoxyethyl acrylate, 2-(3-toloidylureido)ethyl methacrylate or mixtures thereof; or
iiib) acenaphthylene, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, 2-(3-toloidylureido)ethyl methacrylate or mixtures thereof; or
iiic) acenaphthylene, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, phenyl methacrylate, 3,4-epoxycyclohexylmethyl methacrylate, glycidyl methacrylate, 2-(3-toloidylureido)ethyl methacrylate or mixtures thereof; or
iiid) acenaphthylenes, maleic anhydride, N-phenylmaleimide, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, N,N-dimethylacrylamide, N-tert-butylacrylamide, N-isopropylacrylamide, isobornyl acrylate, acrylonitrile, methacrylonitrile, phenyl methacrylate, 2-(3-toloidylureido)ethyl methacrylate or mixtures thereof.

3. The process as claimed in claim 1, characterized in that
the at least two different monomers A are polymerized; preferably one monomer A is N-phenylmaleimide and the other monomer A is selected from acenaphthylenes, maleic anhydride, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxy styrene, alpha-methylstyrene, 3-methyl styrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, stearyl acrylate, vinyl acetate, n-butyl methacrylate, methyl acrylate, 2-phenoxyethyl acrylate, and 2-(3-toloidylureido)ethyl methacrylate.

4. The process as claimed in claim 1, characterized in that
i) the at least one monomer B has a molecular weight of less than 2000 g/mol; and/or
ii) the at least one monomer B contains imidazole, pyridine or derivatives thereof as aromatic heterocyclic group containing at least one nitrogen atom in the ring; and/or
iii) in that the aromatic heterocyclic group containing the at least one nitrogen atom in the ring is bonded to the polymer backbone of the resultant copolymer by a spacer group having 2 to 20 atoms; and/or
iv) the at least one monomer B is contained in 20 to 70 mol %, based on the total monomers of the copolymer; and/or
v) the at least one monomer B contains no —OH radical.

5. The process as claimed in claim 1, characterized in that the molar ratio of the monomers A to monomers B is from 30 to 60:40 to 70.

6. The process as claimed in claim 1, characterized in that the at least one radical initiator is a UV radical initiator or a thermal radical initiator; and/or
the at least one radical initiator is contained in less than 10 mol % based on 100 mol % of the monomers A to C.

7. The process as claimed in claim 1, characterized in that the polymerizing
i) is carried out in at least one organic solvent; and/or
ii) is carried out under protective gas atmosphere; and/or
iii) in that further at least one chain transfer agent is used.

8. The process as claimed in claim 1, characterized in that
i) the polymerization is carried out with heating and/or
ii) the reaction time is at least 1 h.

9. A copolymer obtainable by the radical polymerization according to a process of claim 1.

10. An adhesive tape comprising at least one layer of a pressure-sensitive adhesive,
where the adhesive comprises a polymeric film-forming matrix and also a curable composition,
where the curable composition comprises one or more epoxy resins and also at least one curing reagent for epoxy resins,
characterized in that
the curing reagent comprises at least one copolymer as claimed in claim 9 and at least one hardener.

11. The adhesive tape as claimed in claim 10, characterized in that at least one of the epoxy resins of the curable composition is an elastomer-modified epoxy resin and/or a fatty acid-modified epoxy resin.

12. The adhesive tape as claimed in claim 10, characterized in that
the polymeric film-forming matrix used comprises wholly or partly one or more thermoplastic polyurethanes or one or more nonthermoplastic elastomers.

13. The use of the copolymer as claimed in claim 9 as an accelerator in the curing reagent for adhesives, more particularly epoxy-based adhesives.

14. The process as claimed in claim 2, characterized in that the at least two different monomers A are polymerized; preferably one monomer A is N-phenylmaleimide and the other monomer A is selected from acenaphthylenes, maleic anhydride, N-vinylpyrrolidone, 2-vinylnaphthalene, acrylamide, N-vinylcaprolactam, itaconic anhydride, tert-butyl methacrylate, dihydrodicyclopentadienyl acrylate, isobornyl methacrylate, tert-butyl acrylate, acrylic acid, methyl methacrylate, styrene and styrene derivatives, such as 4-acetoxy styrene, alpha-methylstyrene, 3-methyl styrene, 4-methylstyrene, N,N-dimethylacrylamide, N-tert-butylacrylamide, N-isopropylacrylamide, isobornyl acrylate, acrylonitrile, methacrylonitrile, hydroxyethyl methacrylate, cyclohexyl methacrylate, tert-butylcyclohexyl methacrylate, 3,4-epoxycyclohexylmethyl methacrylate, glycidyl methacrylate, ethyl methacrylate, benzyl methacrylate, phenyl methacrylate, isobutyl methacrylate, stearyl acrylate, vinyl acetate, n-butyl methacrylate, methyl acrylate, 2-phenoxyethyl acrylate, and 2-(3-toloidylureido)ethyl methacrylate.

15. The process as claimed in claim 2, characterized in that
i) the at least one monomer B has a molecular weight of less than 2000 g/mol; and/or
ii) the at least one monomer B contains imidazole, pyridine or derivatives thereof as aromatic heterocyclic group containing at least one nitrogen atom in the ring; and/or
iii) in that the aromatic heterocyclic group containing the at least one nitrogen atom in the ring is bonded to the polymer backbone of the resultant copolymer by a spacer group having 2 to 20 atoms; and/or
iv) the at least one monomer B is contained in 20 to 70 mol %, based on the total monomers of the copolymer; and/or
v) the at least one monomer B contains no —OH radical.

16. The process as claimed in claim 3, characterized in that
i) the at least one monomer B has a molecular weight of less than 2000 g/mol; and/or
ii) the at least one monomer B contains imidazole, pyridine or derivatives thereof as aromatic heterocyclic group containing at least one nitrogen atom in the ring; and/or
iii) in that the aromatic heterocyclic group containing the at least one nitrogen atom in the ring is bonded to the polymer backbone of the resultant copolymer by a spacer group having 2 to 20 atoms; and/or
iv) the at least one monomer B is contained in 20 to 70 mol %, based on the total monomers of the copolymer; and/or
v) the at least one monomer B contains no —OH radical.

17. The process as claimed in claim 2, characterized in that the molar ratio of the monomers A to monomers B is from 30 to 60:40 to 70.

18. The process as claimed in claim 3, characterized in that the molar ratio of the monomers A to monomers B is from 30 to 60:40 to 70.

19. The process as claimed in claim 4, characterized in that the molar ratio of the monomers A to monomers B is from 30 to 60:40 to 70.

20. The process as claimed in claim 2, characterized in that the at least one radical initiator is a UV radical initiator or a thermal radical initiator; and/or
the at least one radical initiator is contained in less than 10 mol % based on 100 mol % of the monomers A to C.
